(19) United States
(12) Patent Application Publication
(10) Pub. No.: US 2015/0102989 A1
(43) Pub. Date: Apr. 16, 2015

(54) Equalizing Method and Driving Device Thereof

(71) Applicant: NOVATEK Microelectronics Corp., Hsin-Chu (TW)

(72) Inventors: Hsueh-Yi Lee, Hsinchu County (TW); Yi-Nung Hu, Kaohsiung City (TW)

(73) Assignee: NOVATEK Microelectronics Corp., Hsin-Chu (TW)

(21) Appl. No.: 14/187,310

(22) Filed: Feb. 23, 2014

(30) Foreign Application Priority Data
Oct. 15, 2013 (TW) 102137197

(51) Int. Cl. G09G 3/36

(52) U.S. Cl. CPC G09G 3/3614; G09G 3/3622; G09G 3/3696
USPC 345/96

(57) ABSTRACT

An equalizing method for a driving device includes determining whether a polarity of an output voltage changes from a first time period to a second time period according to an inversion method of a display device coupled to the driving device, for generating a polarity inversion signal; and determining whether to perform an equalization operation on the output voltage in a switching period between the first time period and the second time period according to the polarity inversion signal, current line information and previous line information.

### BACKGROUND OF THE INVENTION

1. Field of the Invention

The present invention relates to an equalizing method capable of reducing power consumption and a driving device thereof, and more particularly, to an equalizing method capable of controlling the equalization operation in the driving device according to the inversion method of the driving device for reducing the power consumption and the driving device thereof.

2. Description of the Prior Art

A liquid crystal display (LCD) is a flat panel display which has the advantages of low radiation, light weight and low power consumption and is widely used in various information technology (IT) products, such as notebook computers, personal digital assistants (PDA), and mobile phones. An active matrix thin film transistor (TFT) LCD is the most commonly used transistor type in LCD families, especially in the large-size LCD family. A driving system installed in the LCD, includes a timing controller, source drivers and gate drivers. The source and gate drivers respectively control data lines and scan lines, which intersect to form a cell matrix. Each intersection is a cell including crystal display molecules and a TFT. In the driving system, the gate drivers are responsible for transmitting scan signals to gates of TFTs to turn on the TFTs on the panel. The source drivers are responsible for converting digital image data, sent by the timing controller, into analog voltage signals and outputting the voltage signals to sources of the TFTs. When the TFT receives the voltage signals, a corresponding liquid crystal molecule has a terminal whose voltage changes to equalize the drain voltage of the TFT, and thereby changes its own twist angle. The rate that light penetrates the liquid crystal molecule is changed accordingly, and thus different colors can be displayed on the panel.

In the conventional source driver, the equalization operations such as pre-charging and charge sharing are utilized for reducing the power consumption of driving the LCD. For optimizing the power consumption, the source driving not only needs to adopt different methods for reducing the power consumption according to the driving method (e.g. the direct-current (DC) biasing driving method or the alternating-current (AC) biasing driving method) and the inversion method of the LCD, but also needs to control the equalization operation according to the output voltage of the source driver. Moreover, the DC biasing driving method and the AC biasing driving method have multiple inversion methods such as line inversion, frame inversion, dot inversion, multi-dot inversion and column inversion, respectively. The characteristics of the output voltage of the source driver change with different inversion methods. Thus, how to adaptively control the equalization operation in the source driver according to the characteristics of the output voltage of the source driver becomes a topic to be discussed.

### SUMMARY OF THE INVENTION

In order to solve the above problem, the present invention provides an equalizing method suitable for all kinds of inversion methods of the LCD and driving device thereof, for optimizing the power consumption of the source driver and reducing the burden of the designers.

The present invention discloses an equalizing method for a driving device, the equalizing method comprising determining whether a polarity of an output voltage changes from a first time period to a second time period according to an inversion method of a display device coupled to the driving device, for generating a polarity inversion signal; and determining whether to perform an equalization operation on the output voltage in a switching period between the first time period and the second time period according to the polarity inversion signal, current line information and previous line information.

The present invention further discloses a driving device for a display system, comprising a driving module, for generating an output voltage according to current line information; and an equalization module, comprising a polarity determining unit, for determining whether a polarity of the output voltage changes from a first time period to a second time period according to an inversion method of the display system, to generate a polarity inversion signal; a determining unit, coupled to the polarity determining unit for generating an equalization control signal and a reset signal according to a polarity inversion signal, the current line information and a previous information; and an equalization unit, coupled to the driving module and the determining unit for determining whether to perform an equalization operation on the output voltage in a switching period between the first time period and the second time period according to the equalization control signal and the reset signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a driving device according to an embodiment of the present invention.

FIGS. 2A-2D are schematic diagrams of related signals when the driving device shown in FIG. 1 operates.

FIG. 3 is a schematic diagram of a realization method of the driving device shown in FIG. 1.

FIG. 4 is a schematic diagram of another realization method of the driving device shown in FIG. 1.

FIG. 5 is a flowchart of an equalizing method according to an embodiment of the present invention.

### DETAILED DESCRIPTION

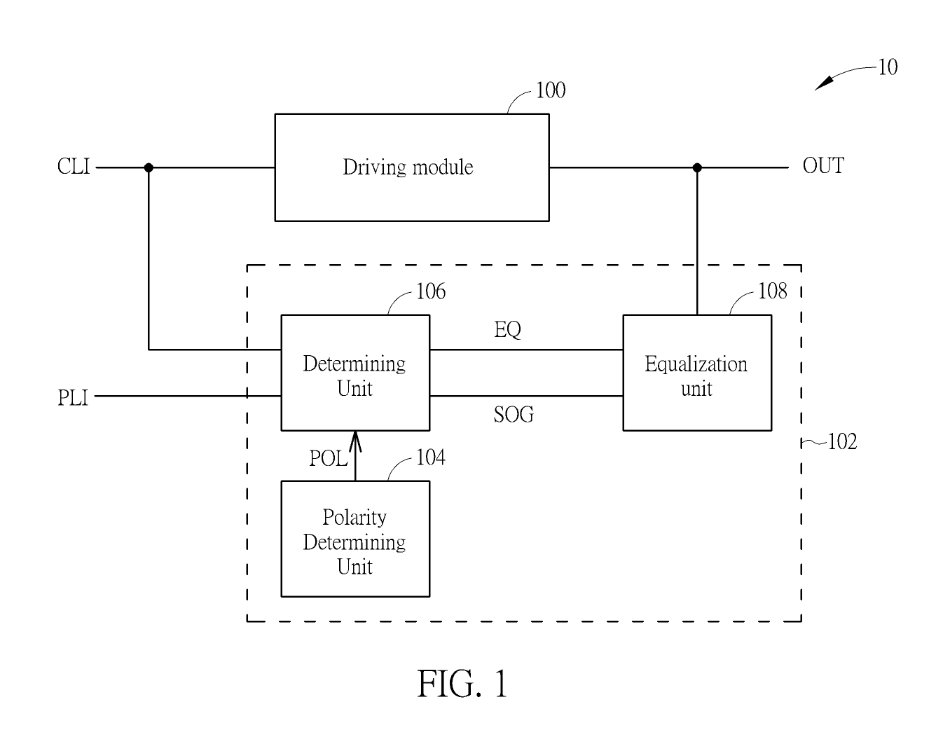

Please refer to FIG. 1, which is a schematic diagram of a driving device 10 according to an embodiment of the present invention. The driving device 10 is utilized for generating an output voltage OUT to a display system (not shown in FIG. 1) according to current line information CLI and previous line information PLI. As shown in FIG. 1, the driving device 10 comprises a driving module 100 and an equalization module 102. The driving module 100 is utilized for generating the output voltage OUT according to the current line information CLI. The equalization module 102 comprises a polarity determining unit 104, a determining unit 106 and an equalization unit 108. The equalization module 102 is coupled to the driving module 100, for determining whether the polarity of the output voltage OUT changes between the contiguous time periods according to the inversion method of the display system and determining voltage variance of the output voltage OUT among the contiguous time periods, to determine whether to perform an equalization operation on the output voltage OUT. The equalization operation performed by the equalization module 102 may be a pre-charge operation or a charge sharing operation, and is not limited herein. Via the equalization module 102, the driving device 10 adaptively decides whether to perform the equalization operation according to the inversion method of the display system and the voltage variations of the output voltages OUT among the contiguous time periods. The power consumption of the driving device 10 can be optimized, therefore.

In detail, the previous line information PLI and the current line information CLI are utilized for instructing a previous target voltage OUT_TP1 and a current target voltage OUT_TP2 corresponding to contiguous time periods TP1 and TP2, respectively. The previous target voltage OUT_TP1 and the current target voltage OUT_TP2 correspond to adjacent data lines in the display system, respectively. According to the inversion method of the display system, the polarity determining unit 104 determines whether the polarity of the output voltage OUT charges from the time period TP1 to the time period TP2 (i.e. whether the polarity of the previous target voltage OUT_TP1 and that of the current target voltage OUT_TP2 are the same), for outputting a polarity inversion signal POL. For example, the polarity of the previous target voltage OUT_TP1 is different from that of the current target voltage OUT_TP2 when the inversion method of the display system is the dot inversion. When the inversion method of the display system is the column inversion, the polarity of the previous target voltage OUT_TP1 and that of the current target voltage OUT_TP2 are the same.

According to the polarity inversion signal POL, the determining unit 106 adopts difference methods to determine whether to perform the equalization operation on the output voltage OUT. When the polarity inversion signal POL indicates that the polarity of the previous target voltage OUT_TP1 is different from that of the current target voltage OUT_TP2, the determining unit 106 first resets the output voltage OUT to the ground voltage GND in a switching period T_EQ between the time periods TP1 and TP2 via adjusting a reset signal SOG. Next, the determining unit 106 determines a voltage difference between the current target voltage OUT_TP2 and the ground voltage GND according to the current line information CLI, for determining whether to perform the equalization operation on the output voltage OUT in the switching period T_EQ.

For example, if the absolute value of the current target voltage OUT_TP2 is greater than a threshold voltage TH_P1, the determining unit 106 determines that the voltage difference between the current target voltage OUT_TP2 and the ground voltage GND so great that the driving module 100 needs to consume a significant amount of current to make the output voltage OUT achieve the current target voltage OUT_TP2 from the ground voltage GND. In such a condition, the determining unit 106 controls the equalization unit 108, via adjusting an equalization control signal EQ, to perform the equalization operation, for reducing the power consumption of the driving device 10. Besides, if the absolute value of the current target voltage OUT_TP2 is smaller than a threshold voltage TH_P2, the voltage difference between the current target voltage OUT_TP2 and the ground voltage GND is small. In such a condition, the power consumption of the driving device 10 increases if performing the equalization operation. Thus, the determining unit 106 controls the equalization unit 108, via adjusting the equalization control signal EQ, not to perform the equalization operation and to maintain the output voltage OUT.

On the other hand, when the polarity inversion signal POL indicates that the polarity of the previous target voltage OUT_TP1 and that of the current target voltage OUT_TP2 are the same, the determining unit 106 determines a voltage difference between the previous target voltage OUT_TP1 and the current target voltage OUT_TP2 according to the previous line information PLI and the current line information CLI, for determining whether to perform the equalization operation within the switching period T_EQ. In this embodiment, if the absolute value of the current target voltage OUT_TP1 is greater than a threshold voltage TH_P3 and the absolute value of the current voltage OUT_TP2 is smaller than a threshold voltage TH_P4, the determining unit 106 determines the voltage difference between the previous target voltage OUT_TP1 and the current target voltage OUT_TP2 is so great that the driving module 100 needs to consume significant amount of current on making the output voltage OUT achieving the current target voltage OUT_TP2 from the previous target voltage OUT_TP1. The determining unit 106 controls the equalization unit 108, via adjusting the equalization control signal EQ, to perform the equalization operation, therefore, for reducing the power consumption of the driving module 100.

In addition, when both the absolute value of the previous target voltage OUT_TP1 and that of the current target voltage OUT_TP2 are greater than the threshold voltage TH_P3 or both the absolute value of the previous target voltage OUT_TP1 and that of the current target voltage OUT_TP2 are smaller than the threshold voltage TH_P4, the determining unit 106 determines the voltage difference between the previous target voltage OUT_TP1 and the current target voltage OUT_TP2 is small and the power consumption of the driving device 10 increases if performing the equalization operation. The determining unit 106 therefore adjusts the equalization control signal EQ for controlling the equalization unit 108 not to perform the equalization operation and to maintain the output voltage OUT. According to the above procedure, the driving device 10 adaptively determines whether to perform the equalization operation according to the inversion method and the output voltage OUT. The power consumption of the driving device 10 can be optimized, therefore.

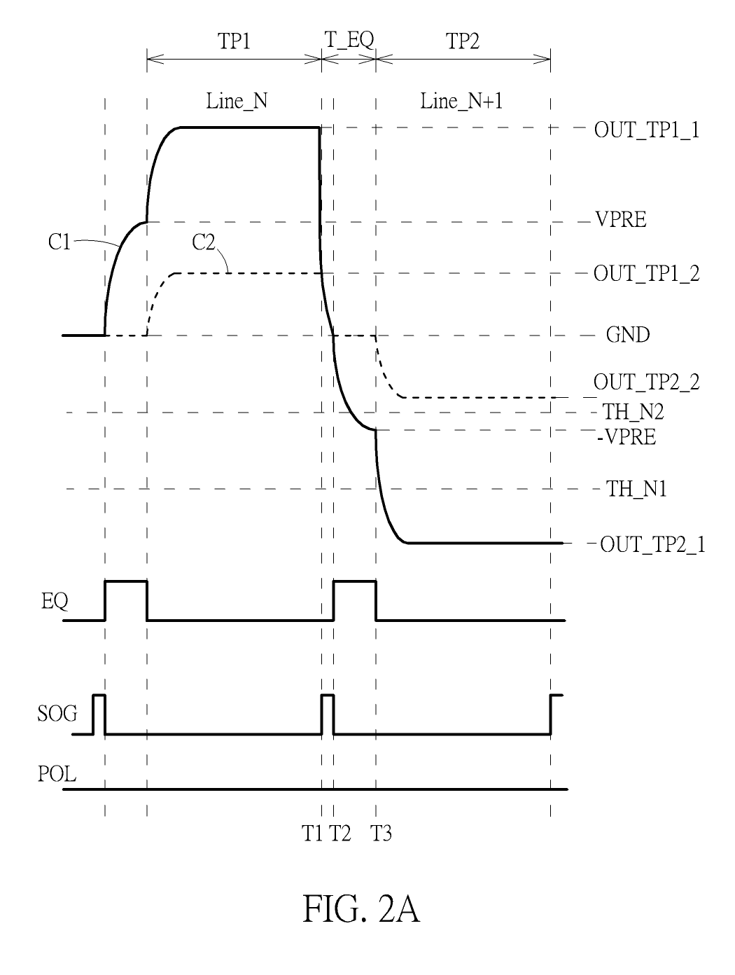

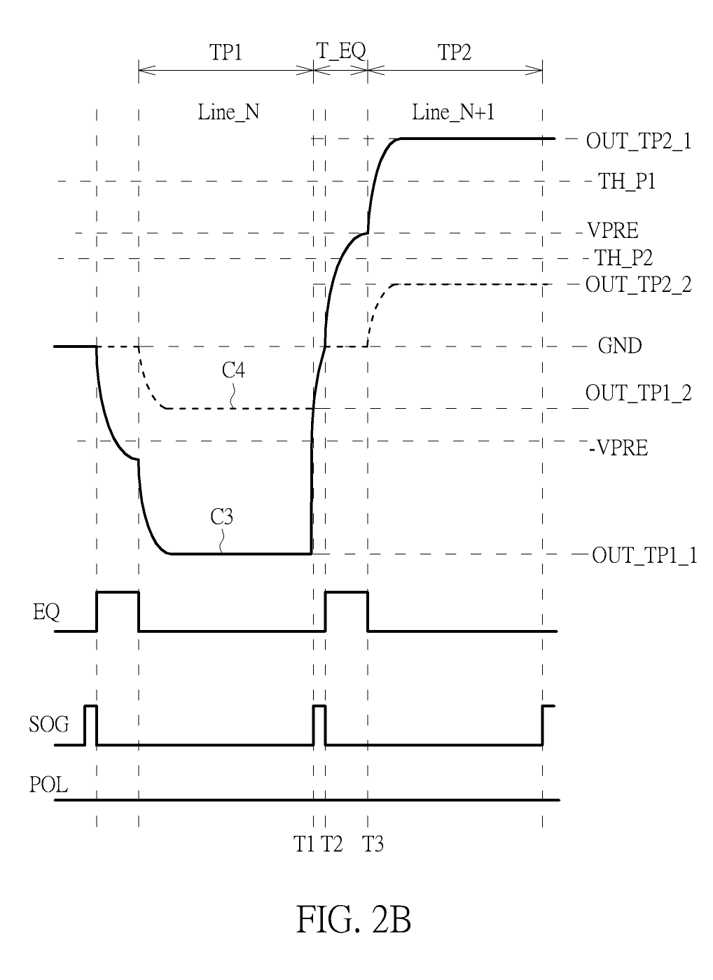

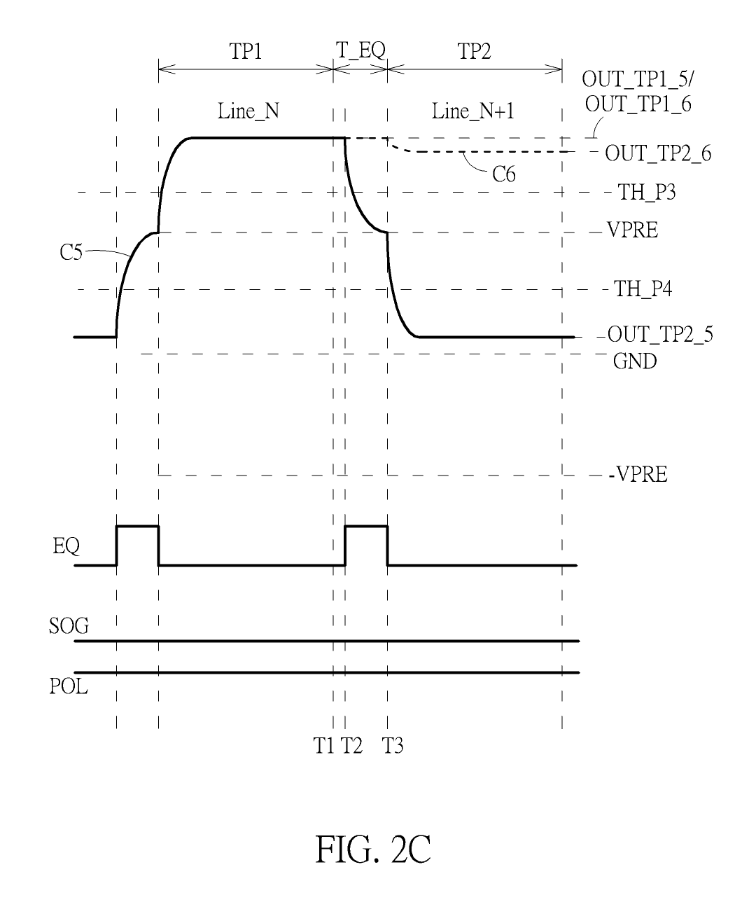

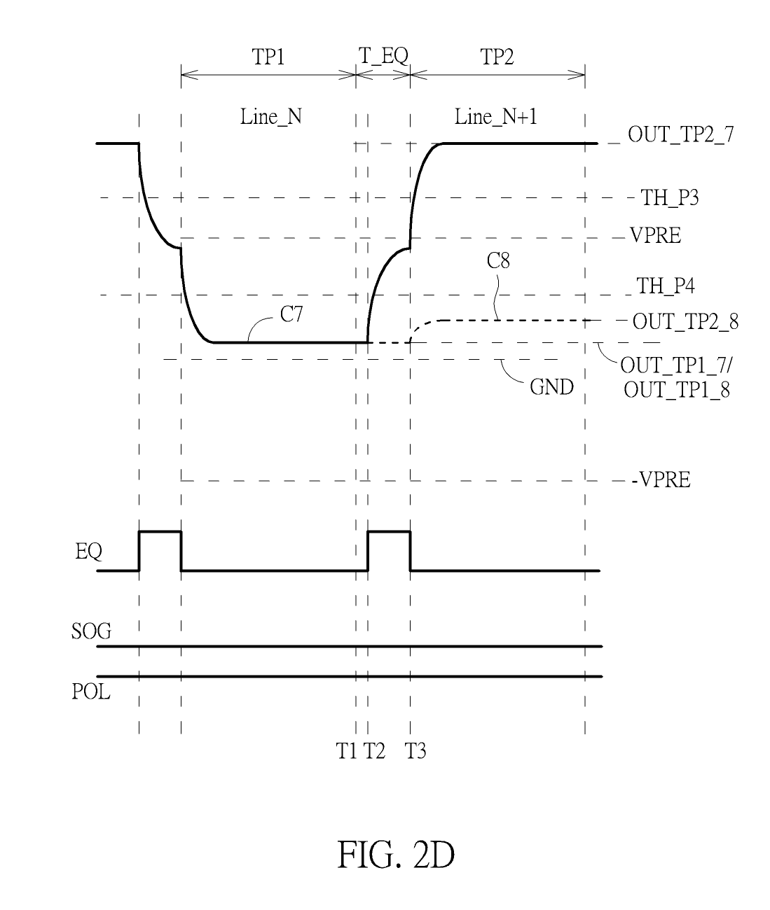

Please refer to FIGS. 2A-2D, which are schematic diagrams of related signals when the driving device 10 shown in FIG. 1 operates. In FIG. 2, the output voltage OUT corresponds to a data line LINE_N of the display system in the time period TP1 and corresponds to a data line LINE_N+1, which is adjacent to the data line LINE_N, of the display system in the time period TP2. As shown as a curve C1 in FIG. 2, the inversion method of the display system is the dot inversion and the polarity determining unit 104 outputs the polarity inversion signal POL with low logic level for indicating that the polarity of the output voltage changes from the time period TP1 to the time period TP2 (i.e. the polarity of the previous target voltage OUT_TP1_{—}1 is different from that of the current target voltage OUT_TP2_{—}1). The determining unit 106 adjusts the reset signal SOG to high logic level at a time T1 (i.e. at the beginning of the switching period T_EQ), for resetting the output voltage OUT to the ground voltage GND and finishing the resetting operation at a time T2. Next, the determining unit 106 determines that the current target voltage OUT_TP2_{—}1 is smaller than a threshold voltage TH_N1, which means that the absolute value of the current target voltage OUT_TP2_{—}1 is greater than a threshold voltage TH_P1, wherein |TH_N1|=TH_P1. The determining unit 106 adjusts the equalization control signal EQ to the high logic level for pre-charging the output voltage OUT to a pre-charge voltage (−VRE) before a time T3 (i.e. before the end of the switching period). The power consumption of the driving module 100 discharging the output voltage OUT to the current target voltage OUT_TP2_{—}1 is decreased via the pre-charge operation (i.e. the equalization operation). Note that, the method of decreasing power consumption via pre-charging should be well-known to those with ordinary skill in the art, and is not narrated herein for brevity.

Similarly, please refer to a curve C2 shown in FIG. 2A. The determining unit 106 adjusts the reset signal SOG to the high logic level at the time T1, for resetting the output voltage OUT to the ground voltage GND, and adjusts the reset signal SOG to low logic level at the time T2 for finishing the resetting operation. Different from the curve C2, the current target voltage OUT_TP_{—}2 of the curve C2 is greater than a threshold voltage TH_N2, which means that the absolute value of the current target voltage OUT_TP2_{—}2 is smaller than a threshold voltage TH_P2, wherein |TH_N2|=TH_P2. The determining unit 106 determines the voltage difference between the current target voltage OUT_TP2_{—}2 and the ground voltage GND is small and the power consumption of the driving module 100 increases if the equalization unit 108 pre-charges the output voltage OUT to the pre-charge voltage (−VPRE) in the switching period T_EQ. Thus, the determining unit 106 does not adjust the equalization control signal EQ to maintain the output voltage OUT in the switching period T_EQ. The power consumption of the driving module 100 is therefore optimized. Further, please refer to curves C3 and C4 shown in FIG. 2B. The operation procedures of the driving device 10 shown in the curves C3 and C4 are similar with the curves C1 and C2, respectively, and are not described herein for brevity.

Please refer to FIG. 2C, wherein the inversion method of the display system is the column inversion in this embodiment. The polarity determining unit 104 outputs the polarity inversion POL with high logic level for indicating that the polarity of the output voltage OUT remains the same from the time period TP1 to the time period TP2. The determining unit 106 adjusts the reset signal SOG to low logic level for instructing the equalization unit 108 not to perform the resetting operation. As shown in a curve C5 in FIG. 2C, the determining unit 106 determines that the previous target voltage OUT_TP1_{—}5 is greater than a threshold voltage TH_P3 and the current target voltage OUT_TP2_{—}5 is smaller than a threshold voltage TH_P4 according to the previous line information PLI and the current line information CLI. In such a condition, the determining unit adjusts the equalization control signal EQ to high logic level at the time T2, for pre-charging the output voltage OUT to a pre-charge voltage VPRE before the time T3. The power consumption of the driving module 100 discharging the output voltage OUT to the current target voltage OUT_TP2_{—}5 therefore can be decreased.

In addition, please refer to a curve C6 shown in FIG. 2C. The polarity determining unit 104 outputs the polarity inversion POL with high logic level for indicating that the polarity of the output voltage OUT remains the same from the time period TP1 to the time period TP2. The determining unit 106 adjusts the reset signal SOG to low logic level for instructing the equalization unit 108 not to perform the resetting operation. Different from the curve C5, the determining unit 106 determines that both the absolute value of the previous target voltage OUT_TP1_{—}6 and that of the current target voltage OUT_TP2_{—}6 are greater than the threshold voltage TH_P3. The power consumption of the driving device 10 increases if the equalization unit 108 performs the equalization operation. Thus, the determining unit 106 maintains the equalization control signal EQ to low logic level for maintaining the output voltage OUT. The power consumption of the driving device 10 can be optimized, therefore.

Besides, please refer to curves C7 and C8 shown in FIG. 2D. The detailed operations of driving device 10 corresponding to the curves C7 and C8 are similar with the curves C5 and C6 shown in FIG. 2C, respectively, and are not narrated herein for brevity.

Please note that, the above embodiments determines whether the polarity of the output voltage corresponding to the adjacent data lines remains the same according to the inversion method of the display system. If the polarity of the output voltage corresponding to the adjacent data lines changes, the above embodiments determines whether to perform the equalization operation according to the current target voltage of the output voltage. Besides, if the polarity of the output voltage corresponding to the adjacent data lines remains the same, the above embodiments determines whether to perform the equalization operation according to difference between the previous target voltage and the current target voltage of the output voltage. As a result, the power consumption of the driving device can be optimized. According to the different applications and design concepts, those with ordinary skill in the art may observe appropriate alternations and modifications. For example, the threshold voltage TH_P1 and the threshold voltage TH_P2 may be the same and the threshold voltage TH_P3 and the threshold voltage TH_P4 may be the same

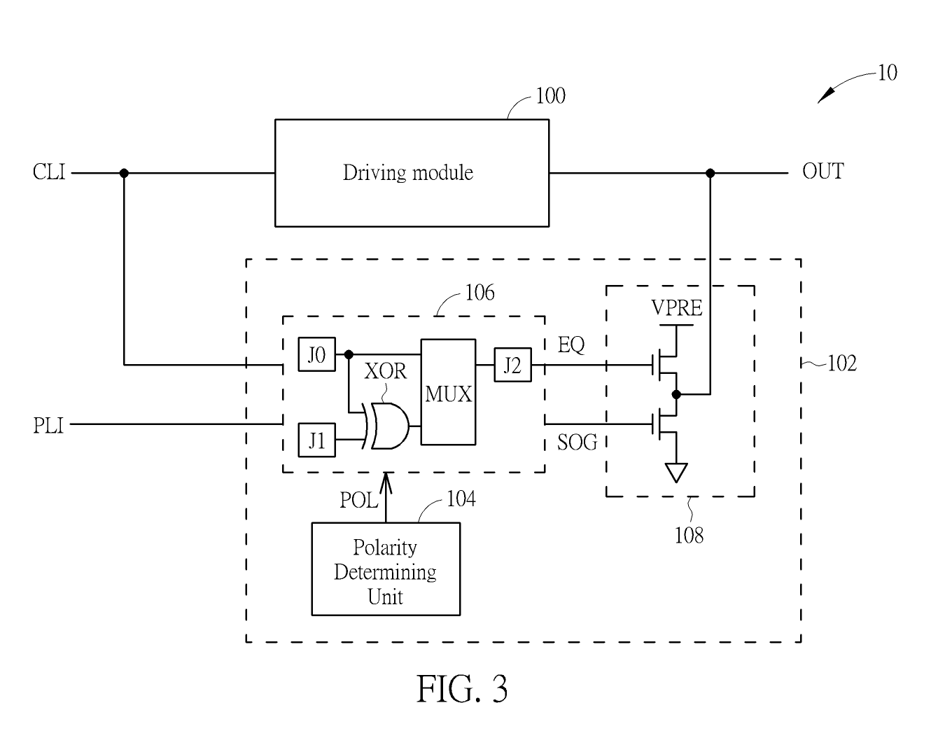

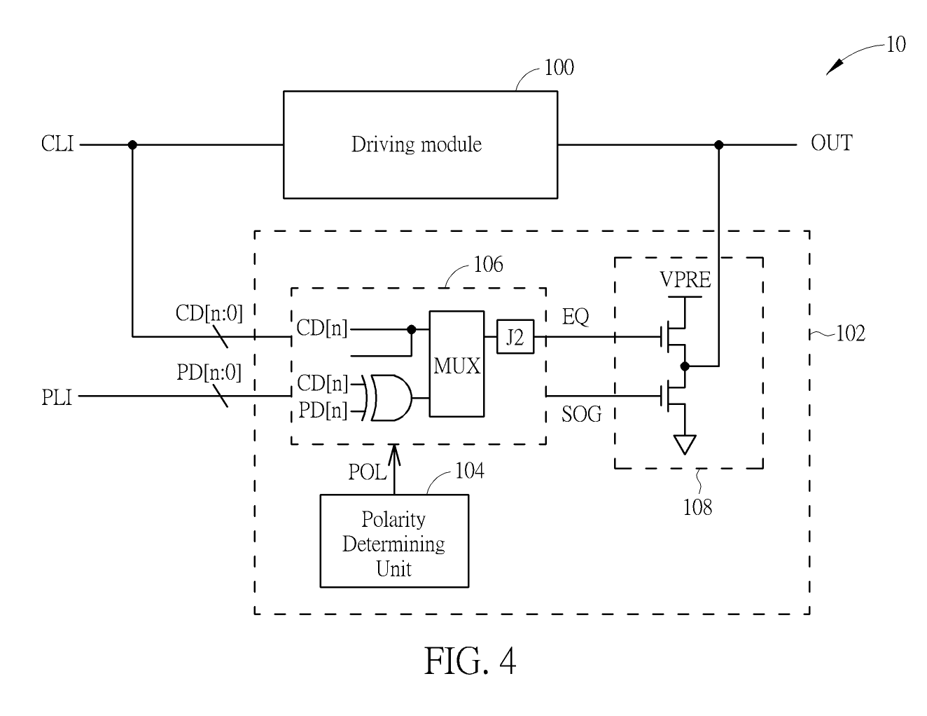

Please refer to FIG. 3, which is a schematic diagram of a realization method of the driving device 10 shown in FIG. 1. As shown in FIG. 3, the determining unit is realized by registers J0-J2, exclusive-or gate XOR and a multiplexer MUX and the equalization unit 108 is realized by the switches SW1 and SW2. As to the detailed operation procedures of the driving device 10 shown in FIG. 4, please refer to the following. In this embodiment, the threshold voltages TH_P1-TH_P4 are equal to a threshold voltage TH. First, the determining unit 106 determines whether the absolute value of the current target voltage OUT_TP2 of the output voltage OUT is greater than the threshold voltage TH according to the current line information CLI, and stores the determination result in the register J0. For example, if the absolute value of the current target voltage OUT_TP2 is greater than the threshold voltage TH, the determining unit 106 stores a high logic signal in the register J0; otherwise, the determining unit 106 stores a low logic signal in the register J0. Similarly, the determining unit 106 determines whether the absolute value of the previous target voltage OUT_TP1 is greater than the threshold voltage TH according to the previous line information PLI, and stores the determination result in the register J1. The two input ports of the exclusive-or gate XOR are coupled to the registers J0 and J1, respectively. According to the feature of the exclusive-or gate XOR, the output of the exclusive-or gate XOR being a signal with high logic level means that one of the absolute values of the previous target voltage OUT_TP1 and the current target voltage OUT_TP2 is greater than the threshold voltage TH; and the output of the exclusive-or gate XOR being a signal with low logic level means that both the absolute values of the previous target voltage OUT_TP1 and the current target voltage OUT_TP2 are greater or smaller than the threshold voltage TH. According to the polarity inversion signal POL, the multiplexer MUX can select the register J0 or the output of the exclusive-or gate XOR as the equalization control signal EQ, and stores the equalization control signal EQ in the register J2. Then, the register J2 outputs the equalization control signal EQ according to the clock signal (not shown in FIG. 3) of the driving module 100, to complete the equalization operation.

For example, when the polarity inversion signal POL indicates that the polarity of the output voltage OUT changes within the contiguous time periods TP1 and TP2, the determining unit 106 first adjusts the reset signal SOG according to the clock signal of the driving module 100, for conducting the switch SW2 in the switching period T_EQ, to reset the output voltage OUT to the ground voltage GND. The multiplexer MUX selects the register J0 as the equalization control signal EQ, for performing the equalization operation according to whether the current target voltage OUT_TP2 corresponding to the time period TP2 is greater than the threshold voltage TH. If the absolute value of the current target voltage OUT_TP2 is greater than the threshold voltage TH, the register J0 outputs the signal with high logic level to the register J2. Then, the register J2 outputs the equalization control signal EQ according to the clock signal of the driving module 100, for conducting the switch SW1, and the output voltage OUT is therefore pre-charged to the pre-charge voltage VPRE. In this embodiment, the polarity of the pre-charge voltage VPRE may alter according to the current target voltage OUT_TP2. Besides, if the absolute value of the current target voltage OUT_TP2 is smaller than the threshold voltage TH, the register J0 outputs the signal with low logic level to the register J2. Next, the register J2 outputs the equalization control signal EQ according to the clock signal of the driving module 100, for disconnecting the switch SW1, and output voltage OUT maintains at the ground voltage GND. As a result, the power consumption of the driving device 10 can be optimized.

On the other hand, when the polarity inversion signal POL indicates that the polarity of the output voltage OUT remains the same in the contiguous time periods TP1 and TP2, the multiplexer selects the output of the exclusive-or gate XOR as the equalization control signal EQ for performing the equalization operation according to whether the absolute value of the previous target voltage OUT_TP1 corresponding to the time period TP1 and the absolute value of the current target voltage OUT_TP2 corresponding to the time period TP2 are greater than the threshold voltage TH. When one of the absolute value of the previous target voltage OUT_TP1 and the absolute value of the current target voltage OUT_TP2 is greater than the threshold voltage TH, the exclusive-or gate XOR outputs the signal with high logic level to the register J2. Then, the register J2 outputs the equalization control signal EQ according to the clock signal of the driving module 100, for conducting the switch SW1. The output voltage OUT is therefore pre-charged to the pre-charge voltage VPRE. In addition, when both the absolute value of the previous target voltage OUT_TP1 and the absolute value of the current target voltage OUT_TP2 are greater or smaller than the threshold voltage TH the exclusive-or gate XOR outputs the signal with low logic level to the register J2. Next, the register J2 outputs the equalization control signal EQ according to the clock signal of the driving module 100, for disconnecting the switch SW1. The output voltage OUT maintains at the previous target voltage OUT_TP1, therefore. As a result, the power consumption of the driving device 10 can be effectively reduced.

Further, if the threshold voltage TH is half the supply voltage of the driving module 100 and the current line information CLI and the previous line information PLI are implemented by n-bit signals CD[n:0] and PD[n:0], the determining unit 106 may utilize the most significant bits (MSBs) of the current line information CLI and the previous line information PLI (i.e. the bit CD[n] and the bit PD[n]) as the output of the registers J0 and J1, respectively. Please refer to FIG. 4, which is another realization method of the driving device 10 shown in FIG. 1. The driving device 10 shown in FIG. 4 is similar to the driving device 10 shown in FIG. 4, thus the signals and components with similar functions use the same symbols. Since the threshold voltages TH_P1-TH_P4 equal half the supply voltage of the driving module 100 in this embodiment, the MSBs of the current line information CLI and the previous line information PLI can be directly used as the outputs of the registers J0 and J1, respectively. Under such a condition, the driving device 10 shown in FIG. 4 can use a simpler circuit to realize the determining unit 106. The detailed operations of the driving device 10 shown in FIG. 4 can be determined by referring to the above, and are not described herein for brevity. Please note that, instead of using the MSBs of the current line information CLI and the previous line information PLI as shown in FIG. 4, the determining unit 106 may use other bits of the current line information CLI and the previous line information PLI as the reference of determining the current target voltage OUT_TP2 and the previous target voltage OUT_TP1 according to the threshold voltages TH_P1-TH_P4 with different voltages.

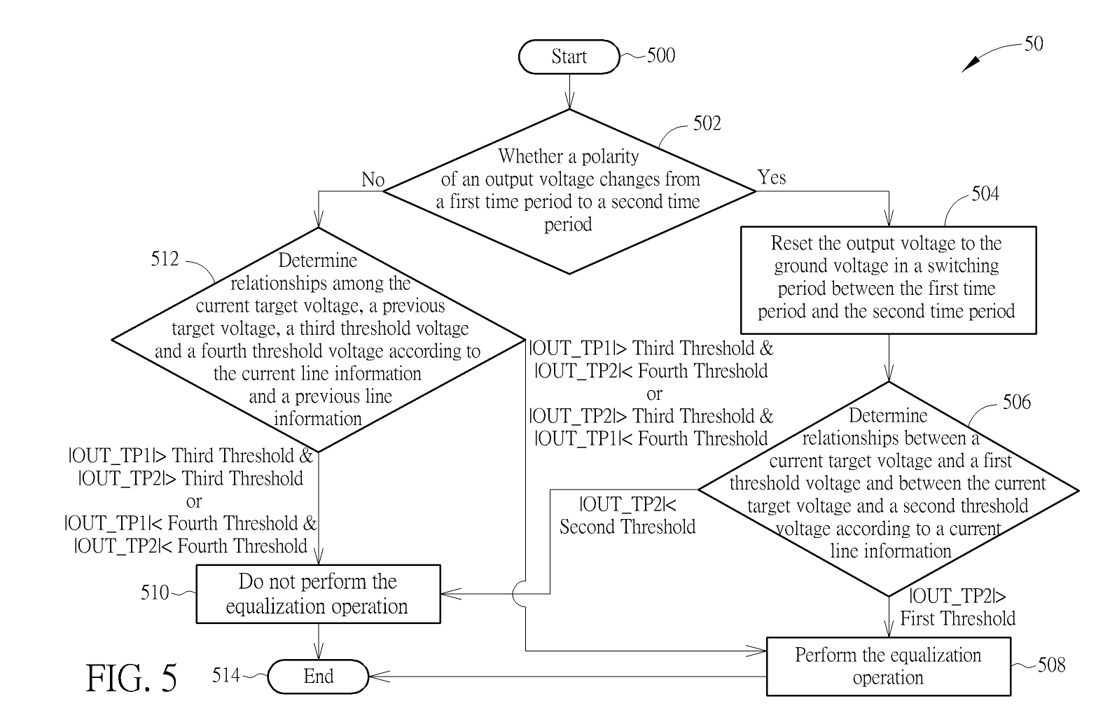

The procedures of the equalization module 102 adopts different methods for determining whether to perform the equalization operation can be summarized into an equalizing method 50 as shown in FIG. 5. Please note that, if the same result can be acquired, the sequence of the equalizing method 50 is not limited to the sequence shown in FIG. 5. The equalizing method 50 can be utilized in a driving device, and comprises the following steps:

Step 500: Start.

Step 502: Determine whether a polarity of an output voltage changes from a first time period to a second time period according to an inversion method of a display device coupled to the driving device, for generating a polarity inversion signal, when the polarity inversion signal indicates that the polarity of the output voltage changes from the first time period to the second time period, perform step 504; otherwise, perform step 512.

Step 504: Reset the output voltage to the ground voltage in a switching period between the first time period and the second time period.

Step 506: Determine relationships between a current target voltage and a first threshold voltage and between the current target voltage and a second threshold voltage according to current line information, if the absolute value of the current target voltage is greater than the first threshold voltage, perform step 508; and if the absolute value of the current target voltage is smaller than the second threshold voltage, perform step 510.

Step 508: Perform the equalization operation.

Step 510: Do not perform the equalization operation.

Step 512: Determine relationships among the current target voltage, a previous target voltage, a third threshold voltage and a fourth threshold voltage according to the current line information and previous line information; when the absolute value of the previous target voltage is greater than the third threshold voltage and the absolute value of the current target voltage is smaller than the fourth threshold voltage or when the absolute value of the previous target voltage is smaller than the fourth threshold voltage and the absolute value of the current target voltage is greater than the third threshold voltage, perform step 508; and when both previous target voltage and the current target voltage are greater than the third threshold voltage or when both previous target voltage and the current target voltage are smaller than the fourth threshold voltage, perform step 510.

Step 514: End.

According to the equalizing method 50, the driving device can adopt different methods for determining whether to perform the equalization operation according to the inversion method of the display system. The equalization operation may be the pre-charge operation or the charge sharing operation, and is not limited herein. The detailed operations of the equalizing method 50 can be determined by referring to the above, and are not narrated herein for brevity.

To sum up, the equalizing method and the driving device thereof in the above embodiments determines whether the polarity of the output voltage of the driving device changes according to the inversion method of the display system, for adopting different methods to determine whether to perform the equalization operation. In other words, the equalizing method and the driving device thereof in the above embodiments can adaptively control the equalization operation according to the characteristic of the output voltage of the driving device, so as to optimize the power consumption of the driving device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An equalizing method for a driving device, the equalizing method comprising:
determining whether a polarity of an output voltage changes from a first time period to a second time period according to an inversion method of a display device coupled to the driving device, for generating a polarity inversion signal; and
determining whether to perform an equalization operation on the output voltage in a switching period between the first time period and the second time period according to the polarity inversion signal, current line information and previous line information.

2. The equalizing method of claim 1, wherein the equalization operation is a pre-charge operation.

3. The equalizing method of claim 1, wherein the equalization operation is a charge sharing operation.

4. The equalizing method of claim 1, wherein the step of determining whether to perform the equalization operation in the switching period between the first time period and the second time period according to the polarity inversion signal, the current line information and the previous line information comprises:
resetting the output voltage to the ground voltage in the switching period when the polarity inversion signal indicates that the polarity of the output voltage in the first time period is different from the polarity of the output voltage in the second time period; and
determining whether to perform the equalization operation on the output voltage in the switching period according to a current target voltage instructed by the current line information in the second time period and at least one threshold voltage.

5. The equalizing method of claim 4, wherein the step of determining whether to perform the equalization operation on the output voltage in the switching period according to the current target voltage instructed by the current line information in the second time period and the at least one threshold voltage comprises:
performing the equalization operation on the output voltage in the switching period when the absolute value of the current target voltage is greater than a first threshold voltage of the at least one threshold voltage.

6. The equalizing method of claim 4, wherein the step of determining whether to perform the equalization operation on the output voltage in the switching period according to the current target voltage instructed by the current line information in the second time period and the at least one threshold voltage comprises:
maintaining the output voltage in the switching period when the absolute value of the current target voltage is smaller than a first threshold voltage of the at least one threshold voltage.

7. The equalizing method of claim 1, wherein the step of determining whether to perform the equalization operation in the switching period between the first time period and the second time period according to the polarity inversion signal, the current line information and the previous line information comprises:
determining whether to perform the equalization operation on the output voltage in the switching period according to a current target voltage instructed by the current line information in the second time period, a previous target voltage instructed by the previous line information in the first time period and at least one threshold voltage, when the polarity inversion signal indicates that the polarity of the output voltage in the first time period and the polarity of the output voltage in the second time period are the same.

8. The equalizing method of claim 7, wherein the step of determining whether to perform the equalization operation on the output voltage in the switching period according to the current target voltage instructed by the current line information in the second time period, the previous target voltage instructed by the previous line information in the first time period and the at least one threshold voltage comprises:
performing the equalization operation on the output voltage in the switching period when the absolute value of the previous target voltage is greater than a first threshold voltage of the at least one threshold voltage and the absolute value of the current target voltage is smaller than a second threshold voltage of the at least one threshold voltage.

9. The equalizing method of claim 7, wherein the step of determining whether to perform the equalization operation on the output voltage in the switching period according to the current target voltage instructed by the current line information in the second time period, the previous target voltage instructed by the previous line information in the first time period and the at least one threshold voltage comprises:
performing the equalization operation on the output voltage in the switching period when the absolute value of the current target voltage is greater than a first threshold voltage of the at least one threshold voltage and the absolute value of the previous target voltage is smaller than a second threshold voltage of the at least one threshold voltage.

10. The equalizing method of claim 7, wherein the step of determining whether to perform the equalization operation on the output voltage in the switching period according to the current target voltage instructed by the current line information in the second time period, the previous target voltage instructed by the previous line information in the first time period and the at least one threshold voltage comprises:
maintaining the output voltage in the switching period when the previous target voltage is greater than a first threshold voltage of the at least one threshold voltage and the current target voltage is greater than the first threshold voltage.

11. The equalizing method of claim 7, wherein the step of determining whether to perform the equalization operation on the output voltage in the switching period according to the current target voltage instructed by the current line information in the second time period, the previous target voltage instructed by the previous line information in the first time period and the at least one threshold voltage comprises:
maintaining the output voltage in the switching period when the previous target voltage is smaller than a first threshold voltage of the at least one threshold voltage and the current target voltage is smaller than the first threshold voltage.

12. A driving device for a display system, comprising:
a driving module, for generating an output voltage according to current line information; and
an equalization module, comprising:
a polarity determining unit, for determining whether a polarity of the output voltage changes from a first time period to a second time period according to an inversion method of the display system, to generate a polarity inversion signal;
a determining unit, coupled to the polarity determining unit for generating an equalization control signal and a reset signal according to a polarity inversion signal, the current line information and a previous information; and
an equalization unit, coupled to the driving module and the determining unit for determining whether to perform an equalization operation on the output voltage in a switching period between the first time period and the second time period according to the equalization control signal and the reset signal.

13. The driving device of claim 12, wherein the equalization operation is a pre-charge operation.

14. The driving device of claim 12, wherein the equalization operation is a charge sharing operation.

15. The driving device of claim 12, wherein when the polarity inversion signal indicates that the polarity of the output voltage in the first time period is different from the polarity of the output voltage in the second time period, the determining unit resets the output voltage to the ground voltage in the switching period via adjusting the resetting signal and the determining unit further determines whether to perform the equalization operation on the output voltage in the switching period according to a current target voltage instructed by the current line information in the second time period and at least one threshold voltage.

16. The driving device of claim 15, wherein when the absolute value of the current target voltage is greater than a first threshold voltage of the at least one threshold voltage, the determining unit adjusts the equalization control signal for making the equalization unit perform the equalization operation on the output voltage in the switching period.

17. The driving device of claim 15, wherein when the absolute value of the current target voltage is smaller than a first threshold voltage of the at least one threshold voltage, the determining unit adjusts the equalization control signal for making the equalization unit maintain the output voltage in the switching period.

18. The driving device of claim 12, wherein when the polarity inversion signal indicates that the polarity of the output voltage in the first time period and the polarity of the output voltage in the second time period are the same, the determining unit determines whether to perform the equalization operation on the output voltage in the switching period according to a current target voltage instructed by the current line information in the second time period, a previous target voltage instructed by the previous line information in the first time period and at least one threshold voltage.

19. The driving device of claim 18, wherein when the absolute value of the previous target voltage is greater than a first threshold voltage of the at least one threshold voltage and the absolute value of the current target voltage is smaller than a second threshold voltage of the at least one threshold voltage, the determining unit adjusts the equalization control signal for making the equalization unit perform the equalization operation on the output voltage in the switching period.

20. The driving device of claim 18, wherein when the absolute value of the current target voltage is greater than a first threshold voltage of the at least one threshold voltage and the absolute value of the previous target voltage is smaller than a second threshold voltage of the at least one threshold voltage, the determining unit adjusts the equalization control signal for making the equalization unit perform the equalization operation on the output voltage in the switching period.

21. The driving device of claim 18, wherein when the previous target voltage is greater than a first threshold voltage of the at least one threshold voltage and the current target voltage is greater than the first threshold voltage, the determining unit adjusts the equalization control signal for making the equalization unit maintain the output voltage in the switching period.

22. The driving device of claim 18, wherein when the previous target voltage is smaller than a first threshold voltage of the at least one threshold voltage and the current target voltage is smaller than the first threshold voltage, the determining unit adjusts the equalization control signal for making the equalization unit maintain the output voltage in the switching period.
